(19) United States
(12) Patent Application Publication
(10) Pub. No.: US 2007/0062432 A1
(43) Pub. Date: Mar. 22, 2007

(54) Position-adjusting mechanism of an optical engine

(75) Inventors: Wei-Cheng Huang, Chunan (TW); Wen-Tsai Cheng, Chunan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/515,722

(22) Filed: Sep. 6, 2006

(30) Foreign Application Priority Data
Sep. 22, 2005 (TW) 94132906

(51) Int. Cl. H02M 1/12; B63B 15/00; F16M 11/00

(52) U.S. Cl. 114/93; 248/162.1; 363/41

(57) ABSTRACT

A position-adjusting mechanism of an optical engine comprises a base, an adjusting board, two adjusting devices, two fastening devices, and a universal bearing. The adjusting board is set on the base and has two arc slots and two screw holes formed thereon. The adjusting devices are respectively screwed in one of the screw holes and set against the base. One end of the fastening device is inserted through one of the arc slots and is fixed on the base, and the other end of each fastening device is used to press the adjusting board towards the base. The universal bearing is located between the base and the adjusting board and serves as a pivot for rotating the adjusting board against the base.

### RELATED APPLICATIONS

The present application is based on, and claims priority from, Taiwanese Application Serial Number 94132906, filed on Sep. 22, 2005, the disclosure of which is hereby incorporated by reference herein in its entirety.

### FIELD OF THE INVENTION

The present invention relates to a position-adjusting mechanism, and particularly relates to a position-adjusting mechanism for an optical engine.

### BACKGROUND OF THE INVENTION

FIG. 1 is a cross-sectional view of a conventional rear projection display television (RPDTV). A light provided by an optical engine 11 is projected to a reflector 12. The reflected light is then displayed on a screen 13 to form an image.

However, the image displayed on the screen 13 is distorted due to the positional variation or the projecting angle deviation of the optical engine resulted from process tolerance and assembling variation during the RPDTV manufacturing process. Thus, positions of elements, such as the optical engine 11, the reflector 12, and the screen 13, for assembling the RPDTV are calibrated to ensure the quality of the image displayed on the screen 13.

A position-adjusting mechanism 20 is typically provided beneath the optical engine 11 to calibrate the position of the optical engine 11. Referring to FIG. 2, a conventional position-adjusting mechanism 20 comprises a base 22, an adjusting board 24 set on the base 22, four height adjusting screws 26a, 206b, 206c and 206d, and four securing screws 28a, 28b, 28c and 28d. The optical engine 11 is fixed on the adjusting board 24 adjusting board 24 has four slots 23a, 23b, 23c, and 23d, and four corresponding penetrated screw holes 25a, 25b, 25c and 25d. The four penetrated screw holes 25a, 25b, 25c and 25d are used for adapting the four height adjusting screws 26a, 26b, 26c and 26d that are vertically adjustable to define a distance between the base 22 and the adjusting board 24. The four slots 23a, 23b, 23c, and 23d are used for adapting the four securing screws 28a, 28b, 28c and 28d that are horizontally adjustable to define a horizontal orientation of the optical engine 11 and to fix the adjusting board 24 on the base 22. The four height adjusting screws 26a, 26b, 26c and 26d are associated with the four securing screws 28a, 28b, 28c and 28d to define a plane and determine the angle and orientation of the adjusting board 24 inclined towards the base 22. Therefore, the projecting orientation of the optical engine 11 is adjusted via the four height adjusting screws 26a, 26b, 26c and 26d.

However, the above-mentioned position-adjusting mechanism lacks an actual pivot, and adjusting the relative position of the four height adjusting screws is rather complicated. Therefore, it is not so convenient to obtain an accurate incline angle or orientation of the adjusting board.

### SUMMARY OF THE INVENTION

The objective of present invention is to provide an accurate position-adjusting mechanism used for adjusting an optical engine to obtain an accurate incline angle or orientation more easily.

In accordance with the preferred embodiments of the present invention, the position-adjusting mechanism of an optical engine comprises a base, an adjusting board, at least one adjusting device, at least one fastening device and a universal bearing. The adjusting board is set on the base and has at least one arc slot and at least one screw hole formed thereon. The adjusting device is screwed in the screw hole and set against the base. The fastening device inserted through the arc slot, and one end of the fastening device is fixed on the base and the other end of the fastening devices is pressing the adjusting board towards the base. The universal bearing is located between the base and the adjusting board and serves as a pivot for rotating the adjusting board relative to the base.

The universal bearing and the adjusting device define a plane to determine the incline angle and orientation of the adjusting board, whereby the accurate position and the projecting orientation of the optical engine is obtained more easily.

### BRIEF DESCRIPTION OF THE DRAWINGS

Reference is made in detail to the present preferred embodiments of the invention, examples of which are illustrated in the accompanying drawings. Wherever possible, the same reference numbers are used in the drawings and the description to refer to the same or like parts, wherein:

FIG. 1 is a cross-sectional view of a conventional rear projection display television (RPDTV).

FIG. 2 is a perspective view of a conventional position-adjusting mechanism of an optical engine.

FIG. 3A is a perspective view of a position-adjusting mechanism of an optical engine in accordance with a preferred embodiment of the present invention.

FIG. 3B is a cross-sectional view of a position-adjusting mechanism of the optical engine shown in FIG. 3A.

FIG. 3C is a bottom view of a position-adjusting mechanism of the optical engine shown in FIG. 3A.

FIG. 4 is a cross-sectional view of a position-adjusting mechanism of an optical engine in accordance with another preferred embodiment of the present invention.

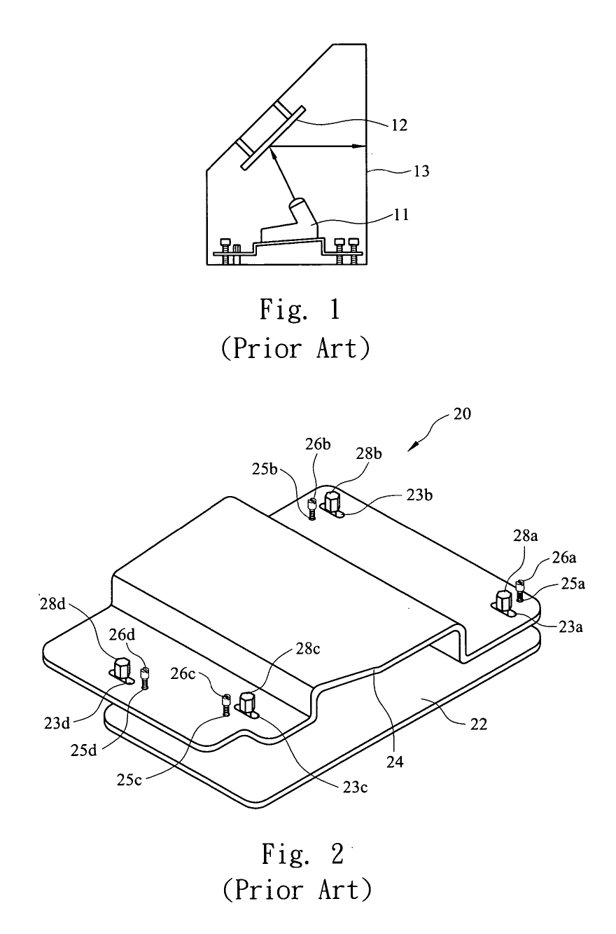

### DETAILED DESCRIPTION OF THE PREFERRED EMBODIMENT

The foregoing aspects and many of the attendant advantages and features of this invention will become more readily appreciated as the same becomes better understood by reference to the following embodiments, when taken in conjunction with accompanying drawings.

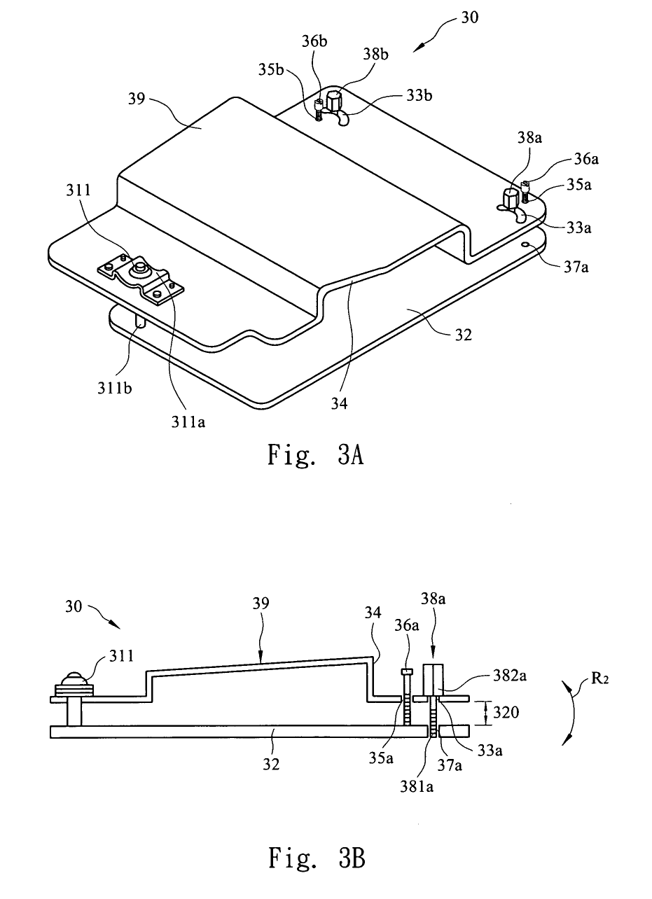

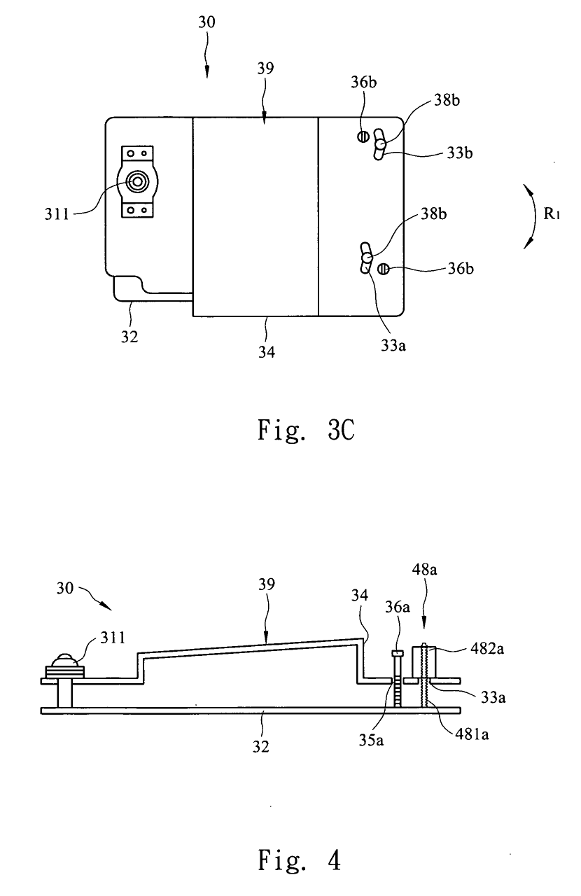

Referring to FIG. 3A, a position-adjusting mechanism 30 of an optical engine according to one embodiment of the present invention comprises a base 32, an adjusting board 34, at least one adjusting device, for example, the adjusting devices 36a and 36b, at least one fastening device, for example, the fastening devices 38a and 38b, and a universal bearing 311.

The base 32 is a base board having at least one engaging opening, for example, the engaging openings 37a and 37b (not shown) formed thereon, and the engaging openings 37a and 37b are used for engaging with the fastening devices 38a and 38b, respectively. The adjusting board 34 is located on the base 32 and has a carrying surface 39, at least one screw hole, for example, the screw holes 35a and 35b, and at least one arc slot, for example, the arc slots 33a and 33b formed on the base 32. The carrying surface 39 is used for carrying an optical engine (not shown). In the embodiment, the adjusting board 34 is a U-shaped rigid board.

The arc slots 33a and 33b associated with the screw holes 35a and 35b respectively are located on one end of the adjusting board 34, and the universal bearing 311 is connected to the other end of the adjusting board 34. The universal bearing 311 serves as the coaxial center of the two arc slots 33a and 33b. In the embodiment, the adjusting devices 36a and 36b are two screws. The adjusting devices 36a and 36b respectively are screwed through the screw holes 35a and 35b set against the base 32. The universal bearing 311 includes a pedestal 311a, a pillar 311b and a universal pivot (not shown). One end of the pillar 311b is fixed on the base 32, and the other end of the pillar 311b is fixed on the adjusting board 34 via the pedestal 311a to keep the adjusting board 34 away from the base 32 at a specific distance. The fastening devices 38a and 38b insert through the arc slots 33a and 33b, and then respectively engage in the engaging openings 37a and 37b of the base 32.

Referring to FIG. 3B, the fastening device, for example, the fastening device 38a comprises a first portion 381a and a second portion 382a protruding therefrom. The first portion 381a inserted through the arc slot 33a is engaged within the engaging opening 37a. In the present embodiment, the engaging opening 37a is a screw hole for fixing the first portion 381a with a plurality of threads. The second portion 382a is set on one side of the adjusting board 34 and opposite to the base 32 and has a diameter greater than a width of the slot 33a. When the calibration of the position-adjusting machine 30 has been done, the second portion 382a of the fastening device 38a is screwed up to force the second portion 382a pressing the adjusting board 34 towards the base 32. Therefore, the adjusting board 34 is fixed on the base 32 such that the orientation of the carrying surface 39 is fixed both horizontally and vertically.

Furthermore, in other embodiments, each fastening device consists of two separate parts. Referring to FIG. 4, the fastening device 48a consists of a first element 481a and a second element 482a. One end of the first element 481a is fixed on the base 32, and the other end is inserted through the arc slot 33a. In the present embodiment, the second element 482a is a threaded nut with a diameter greater than the width of the slot 33a, and set on one side of the adjusting board 34 opposite to the base 32. When the calibration of the position-adjusting machine 30 has been done, the second element 482a is screwed up to press the adjusting board 34 towards the base 32. Therefore, the adjusting board 34 is fixed on the base 32 such that the orientation of the carrying surface 39 is fixed both horizontally and vertically.

Referring to FIG. 3B again, when the fastening devices 38a and 38b are loosened, the distance between the adjusting board 34 and the base 32 are verified via either tightening or loosening the adjusting devices 36a and 36b to define the vertical orientation of the carrying surface 39. In the present invention, the pillar 311b serves as a pivot for rotating the carrying surface 39 along a vertical direction (referring to the arrow R2) to define an incline angle and vertical distance of the carrying surface 39 relative to the base 32.

Further referring to FIG. 3C, when the fastening devices 38a and 38b are loosened, the pillar 311b also serves as a pivot for rotating the adjusting board 34 along a horizontal direction (referring to an arrow R1) within the limitation of the arc slots 33a and 33b. Therefore the horizontal shift of the carrying surface 39 relative to the base 32 is defined by the relative position of the carrying surface 39 against the arc slots 33a and 33b.

According to the aforementioned embodiments, the position-adjusting mechanism of the present invention is that the orientation of the optical engine is calibrated by adjusting relative position of the adjusting board 34 against the base 32 vertically or horizontally. The adjusting devices 36a and 36b and the universal bearing 311 define a plane. The universal bearing 311 serving as a universal pivot for rotating the adjusting board 34 makes the calibration of the position-adjusting mechanism easier.

As is understood by a person skilled in the art, the foregoing preferred embodiments of the present invention are illustrative of the present invention rather than limiting of the present invention and are intended to cover various modifications and similar arrangements included within the spirit and scope of the appended claims, the scope of which should be accorded the broadest interpretation so as to encompass all such modifications and similar structure.

What is claimed is:

1. A position-adjusting mechanism of an optical engine, comprising:
a base;
an adjusting board set on the base and having at least one arc slot and at least one screw hole formed thereon;
at least one adjusting device screwed through the screw hole and set against the base;
at least one fastening device, wherein one end the fastening device is inserted through the arc slot and fixed on the base and the other end of the fastening device presses the adjusting board towards the base; and
a universal bearing located between the base and the adjusting board and serving as a pivot for rotating the adjusting board relative to the base.

2. The position-adjusting mechanism of an optical engine in accordance with claim 1, wherein the adjusting board comprises a carrying surface for carrying the optical engine thereon.

3. The position-adjusting mechanism of an optical engine in accordance with claim 1, wherein the base comprises at least one engaging opening adapted for engaging with the fastening devices.

4. The position-adjusting mechanism of an optical engine in accordance with claim 3, wherein the fastening device comprises:
a first portion, inserted through the arc slot and engaging within the engaging opening; and
a second portion set on one side of the adjusting board and opposite to the base, wherein the second portion has a diameter greater than a width of the arc slot and presses the adjusting board towards the base.

5. The position-adjusting mechanism of an optical engine in accordance with claim 1, wherein the fastening device comprises:
a first element, inserted through the arc slot and fixing on the base; and
a second element, set on one side of the adjusting board opposite to the base, wherein the second portion has a diameter greater than a width of the arc slot, and is screwed with the first element for pressing the adjusting board towards the base.

6. The position-adjusting mechanism of an optical engine in accordance with claim 1, wherein the universal bearing serves as a coaxial center of the arc slot.

7. The position-adjusting mechanism of an optical engine in accordance with claim 1, wherein the universal bearing and the adjusting device define a plane.

8. The position-adjusting mechanism of an optical engine in accordance with claim 1, wherein the fastening device and the adjusting device are set on one end of the base, and the universal bearing is set on the other end of the base.

9. The position-adjusting mechanism of an optical engine in accordance with claim 1, wherein the universal bearing comprises a pedestal, a pillar, and a universal pivot, and one end of the pillar is fixed on the base, and the other end of the pillar is fixed on the adjusting board via the pedestal to keep the adjusting board away from the base at a specific distance.
